(19) United States
(12) Patent Application Publication
(10) Pub. No.: US 2012/0073228 A1
(43) Pub. Date: Mar. 29, 2012

(54) SYNTHETIC BUILDING PANEL

(75) Inventors: Frank Fork, Pataskala, OH (US); Ravi K. Devalapura, New Albany, OH (US); Leonard J. Adzima, Pickerington, OH (US)

(73) Assignee: OWENS CORNING INTELLECTUAL CAPITAL, LLC, Toledo, OH (US)

(21) Appl. No.: 13/245,119

(22) Filed: Sep. 26, 2011

Related U.S. Application Data
(60) Provisional application No. 61/387,114, filed on Sep. 28, 2010.

(51) Int. Cl. E04C 2/22; D03D 25/00; B32B 7/02; B32B 5/00; B32B 9/04; B32B 3/00

(52) U.S. Cl. 52/309.13; 428/411.1; 428/219; 428/220; 428/215; 428/221; 442/181; 428/332

(57) ABSTRACT

A synthetic building panel configured to cover a wall surface is provided. The synthetic building panel includes a plurality of slurry-based layers and a plurality of reinforcement layers interspersed between and in contact with the plurality of slurry-based layers. The material forming the slurry-based layers is a polymer modified inorganic binder material.

### RELATED APPLICATIONS

This application claims the benefit of U.S. Provisional Application No. 61/387,114, filed Sep. 28, 2010, the disclosure of which is incorporated herein by reference.

### BACKGROUND

In the construction of buildings, frequently used construction products include building panels. Building panels can be used to cover the surfaces of walls formed from various framing structures.

In some instances, the building panels are configured for application to the surfaces of the internal walls of the building. Non-limiting examples of internally applied building panels include drywall and wood paneling. The internally applied building panels can have surface finishes that provide various finishing options, such as the non-limiting examples of painting and wall papering.

In other instances, the building panels are configured for application to the external wall surfaces of the building. Non-limiting examples of externally applied building panels include external grade plywood, oriented strand board (commonly referred to as OSB) and exterior grade gypsum. The externally applied building panels can have surface finishes that also provide various finishing options, including the non-limiting options of painting or cladding with various siding materials.

It would be advantageous if building panels could be improved.

### SUMMARY OF THE INVENTION

The above objects, as well as other objects not specifically enumerated, are achieved by a synthetic building panel configured to cover a wall surface. The synthetic building panel includes a plurality of slurry-based layers and a plurality of reinforcement layers interspersed between and in contact with the plurality of slurry-based layers. The material forming the slurry-based layers is a polymer modified inorganic binder material.

According to this invention there is also provided a synthetic building panel configured to cover a wall surface. The synthetic building panel includes a slurry-based layer formed from a polymer modified inorganic binder material mixed with discrete loose fibers. The discrete loose fibers are configured as a reinforcement material.

According to this invention there is also provided a building wall. The building wall includes a plurality of synthetic building panels configured to cover a wall surface. Each of the synthetic building panels has a plurality of slurry-based layers and a plurality of reinforcement layers interspersed between and in contact with the plurality of slurry-based layers. The material forming the slurry-based layers is a polymer modified inorganic binder material. An insulation layer is attached to each of the synthetic building panels and a layer of concrete in contact with each of the insulation layers.

Various objects and advantages of the synthetic building panel will become apparent to those skilled in the art from the following detailed description of the preferred embodiment, when read in light of the accompanying drawings.

### BRIEF DESCRIPTION OF THE DRAWINGS

FIG. 1 is a perspective view of a first embodiment of a synthetic building panel.

FIG. 1a is an exploded perspective view of the synthetic building panel of FIG. 1 illustrating various panel layers.

FIG. 2 is a perspective view of a portion of a side wall of a building illustrating installed synthetic building panels.

FIG. 3 is a schematic view of a manufacturing apparatus configured to manufacture the synthetic building panel of FIG. 1.

FIG. 4 is a perspective view of a second embodiment of a synthetic building panel.

FIG. 4a is an exploded perspective view of the synthetic building panel of FIG. 4.

FIG. 5 is a schematic view of a manufacturing apparatus configured to manufacture the synthetic building panel of FIG. 4.

FIG. 6 is a side view, in elevation, of a first embodiment of a building wall formed with the synthetic building panel of FIG. 4.

FIG. 7 is a side view, in elevation, of a second embodiment of a building wall formed with the synthetic building panel of FIG. 4.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose synthetic building panels. The term “synthetic”, as used herein, is defined to mean pertaining to compounds formed through chemical processes and other processes initiated by human agency, as opposed to compounds formed by natural origin. The term “building”, as used herein, is defined to mean a physical structure having walls. The term “panel”, as used herein, is defined to mean a discrete covering structure having desired structural characteristics for building walls.

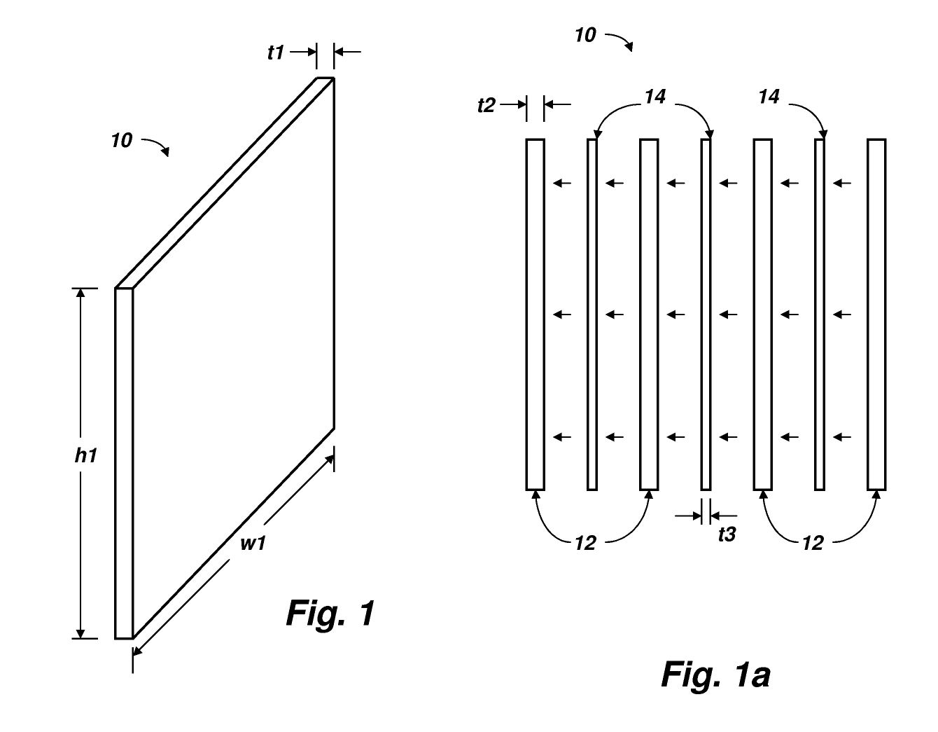

Referring now to FIG. 1, a first embodiment of a synthetic building panel is shown generally at 10. Generally, the synthetic building panel 10 is formed from a reinforced polymer modified inorganic binder material. The reinforced polymer modified inorganic binder material is a low density material that allows the synthetic building panel 10 to be lightweight and fastened to typical building framing with common fasteners, while providing low moisture transmission and significant fire protection characteristics as well as improved mechanical properties, such as the non-limiting example of panel racking. The reinforced polymer modified inorganic binder material will be discussed in more detail below.

Referring again to FIG. 1, the synthetic building panel 10 has a thickness t1. In the illustrated embodiment, the thickness t1 is in a range of from about 0.125 inches (3.175 mm) to about 1.00 inches (25.4 mm). In other embodiments, the thickness t1 can be less than about 0.125 inches (3.175 mm) or more than about 1.00 inches (25.4 mm).

The synthetic building panel 10 has a height h1 and a width w1. In the illustrated embodiment, the height h1 and the width w1 are in a range of from about 24.0 inches (60.9 cm) to about 96.0 inches (243.8 cm). In other embodiments, the height h1 and the width w1 can be less than about 24.0 inches (60.9 cm) or more than about 96.0 inches (243.8 cm).

The reinforced polymer modified inorganic binder material forming the synthetic building panel 10 results in a low density, lightweight panel. In the illustrated embodiment, the reinforced polymer modified inorganic binder material has a density in a range of from about 30.0 pounds per cubic foot (lb/ft³) (0.48 g/cc) to about 180.0 lb/ft³ (2.88 g/cc). In other embodiments, the reinforced polymer modified inorganic binder material can have a density in a range of from about 50.0 lb/ft³ (800.9 kg/m³) to about 150.0 lb/ft³ (2402.7 kg/m³). In still other embodiments, the reinforced polymer modified inorganic binder material can have a density of about 65.0 lb/ft³ (1041.2 kg/m³). While the density of the reinforced polymer modified inorganic binder material has been described above as within a range of from about 30.0 pounds per cubic foot (lb/ft³) (0.48 g/cc) to about 180.0 lb/ft³ (2.88 g/cc), it is within the contemplation of this invention that the density of the reinforced polymer modified inorganic binder material can be less than about 30.0 lb/ft³ (0.48 g/cc) or more than about 180.0 lb/ft³ (2.88 g/cc).

As discussed above, the reinforced polymer modified inorganic binder material is lightweight. In the illustrated embodiment, a 3.0 mm thick portion of the reinforced polymer modified inorganic binder material can have a weight in a range of from about 0.10 pounds per square foot (lb/ft²) (0.49 kg/m²) to about 0.80 lb/ft² (3.90 kg/m²). In other embodiments, a 3.0 mm thick portion of the reinforced polymer modified inorganic binder material can have a weight in a range of from about 0.20 lb/ft² (0.98 kg/m²) to about 0.60 lb/ft² (2.93 kg/m²). In still other embodiments, a 3.0 mm thick portion of the reinforced polymer modified inorganic binder material can have a weight of about 0.32 lb/ft² (1.56 kg/m²). While a 3.0 mm thick portion of the reinforced polymer modified inorganic binder material has been discussed above as having a weight in a range of from about 0.10 lb/ft² (0.49 kg/m²) to about 0.80 lb/ft² (3.90 kg/m²), it is within the contemplation of this invention that a 3.0 mm thick portion of the reinforced polymer modified inorganic binder material can have a weight less than about 0.10 lb/ft² (0.49 kg/m²) or more about 0.80 lb/ft² (3.90 kg/m²).

In addition to providing a low density, lightweight material, the reinforced polymer modified inorganic binder material advantageously provides for low moisture transmission, that is, the synthetic building panel 10 substantially retards the flow of gases (e.g. air and moisture), without requiring the use of a separate vapor or air barrier (not shown) or an incorporated vapor or air barrier. In the illustrated embodiment, the synthetic building panel 10 can have a permeability value in a range of from about 80 coulombs to about 250 coulombs as determined by water vapor transmission tests, such as ASTM C1202. Typical water vapor transmission tests, such as the ASTM C1202, evaluate the transfer of water vapor through semi-permeable and permeable materials over a period of time. In other embodiments, the synthetic building panel 10 can have a permeability rating of less than about 80 coulombs or more than about 250 coulombs.

The synthetic building panel 10 also provides fire test response of 15.0 minutes or higher as provided by fire rating tests, such as ASTM E119. Typical fire rating tests, such as ASTM E119, determine the fire rating of a material in minutes in order to classify the material as a Class A, Class B, etc. per building code requirements.

Referring now to FIG. 1a, the synthetic building panel 10 is formed from a plurality of slurry-based layers 12 and interspersed reinforcement layers 14. As will be discussed below, the slurry-based layers 12 and the reinforcement layers 14 are joined together to form the low density, lightweight synthetic building panel 10.

The slurry-based layers 12 are formed from effective amounts of at least one polymer component, at least one inorganic binder material, water and various production enablers. The polymer components are formed from a mixture of at least one base component and at least one polymer catalyst component. The mixture of the at least one base component and at least one polymer catalyst component can be formed from any moisture insensitive two component polymer system. In the illustrated embodiment, the polymer component is a urea formaldehyde system. In other embodiments, the polymer component can be formed from other polymeric systems including the non-limiting examples of phenolic, epoxy, acrylic and polyamide systems.

The inorganic material is a mixture formed from cementitious material, alumina and low density fillers. In the illustrated embodiment, the cementitious material is a Portland cement has a C3A content greater than about 8.0% and a Blaine measurement of greater than about 500.0 m²/kg. In other embodiments, the cementitious material can have a C3A content greater or less than about 8.0% and a Blaine measurement of greater or less than about 500.0 m²/kg. In still other embodiments, the cementitious material can be other materials, including the non-limiting example of polymer modified gypsum.

The alumina component is configured to provide rapid hardening characteristics to the reinforced polymer modified inorganic binder material. In certain embodiments, the percentage by weight of the alumina can be in a range of from about 10.0% to about 90%. In other embodiments, the percentage by weight of the alumina can be in range of from about 30.0% to about 70%. In still other embodiments, the percentage by weight of the alumina can be about 60.0%. While the percentage by weight of the alumina has been described above as in a range of from about 10.0% to about 90%, it is within the contemplation of this invention that the percentage by weight of the alumina can be less than about 10.0% or more than about 90%. In still other embodiments, the alumina component can be other compounds or combinations of compounds, including the non-limiting examples of aluminum oxide, calcium sulfoaluminate, tetra calcium aluminoferrite and calcium aluminate.

In the illustrated embodiment, the low density filler is an expanded inorganic material, such as for example foamed silica. In other embodiments, the low density filler can be other materials or combinations of materials, such as the non-limiting examples of expanded polymers, or gas generating resins or soaps.

Optionally, secondary catalysts or various production enablers are configured to provide desired characteristics to the reinforced polymer modified inorganic binder material. The secondary catalysts can include ammonium sulphate, citric acid, boric acid and aluminum sulphate. Various non-limiting examples of production enablers include rheology modifiers, density reducers and slurry catalysts. Examples of the rheology modifiers can include sulfonated naphthalene acetone formaldehyde condensate, sulfonated melamine condensate, polycarboxylate, calcium lignosulfonate and sodium lignosulfonate. Examples of the density reducers can include de-dusted aluminum powder, Teflon® material coated aluminum powder and aluminum flake. Non-limiting examples of a slurry catalyst include sodium silicate, sodium hydroxide and triethanolamine.

Referring again to the embodiment illustrated in FIG. 1a, the reinforcement layers 14 are mats formed from fibrous mineral materials. In certain embodiments, the fibrous mineral materials are woven and in other embodiments the mats are formed from non-woven fibrous mineral material. In the illustrated embodiment, the fibrous mineral material is made of glass fibers although other mineral fibers, organic fibers, and cellulose fibers can be used.

While the embodiment illustrated in FIG. 1a shows reinforcement layers 14 interspersed between the slurry-based layers 12, it is within the contemplation of this invention that the synthetic building panel 10 can be formed by mixing discrete loose reinforcement fibers, of varying lengths, with a single slurry-based layer. The resulting synthetic building panel 10 would provide the same low density, lightweight benefits and properties as discussed above.

Referring again to FIG. 1a, the slurry-based layer 12 has a thickness t2 and the reinforcement layer 14 has a thickness t3. In the illustrated embodiment, the thickness t2 of the slurry-based layer 12 is in a range of from about 0.02 inches (0.40 mm) to about 0.04 inches (0.80 mm) and the thickness t3 of the reinforcement layer 14 is in a range of from about 0.0019 inches (0.05 mm) to about 0.011 inches (0.3 mm). In other embodiments, the thickness t2 of the slurry-based layer 12 can be in a range of from about 0.02 inches (0.50 mm) to about 0.027 inches (0.70 mm) and the thickness t3 of the reinforcement layer 14 can be in a range of from about 0.003 inches (0.07 mm) to about 0.01 inches (2.5 mm). In still other embodiments, the thickness t2 of the slurry-based layer 12 can be less than about 0.02 inches (0.40 mm) or more than about 0.04 inches (0.80 mm) and the thickness t3 of the reinforcement layer 14 can be less than about 0.0019 inches (0.05 mm) or more than about 0.011 inches (0.3 mm).

While the embodiment illustrated in FIG. 1a shows a quantity of four slurry-based layers 12 and a quantity of three reinforcement layers 14, it should be appreciated that the quantity of slurry-based layers 12 and the quantity of reinforcement layers 14 can vary depending on parameters such as the non-limiting examples of the thickness t1 of the synthetic building panel 10, the thickness t2 of the slurry based layer 12, the thickness t3 of the reinforcement layer 14, the composition of the slurry based layer 12, the desired strength of the synthetic building panel 10 and the strength of the reinforcement layer 14. As one non-limiting example, a synthetic building panel 10 having a thickness t1 of 3 mm can have a quantity of reinforcement layers 14 in a range of from about 1 to about 20 depending on the materials used for the reinforcement layer 14. In other embodiments, a synthetic building panel 10 having a thickness t1 of 3 mm can have a quantity of reinforcement layers 14 in a range of from about 1 to about 7 depending on the materials used for the reinforcement layer 14.

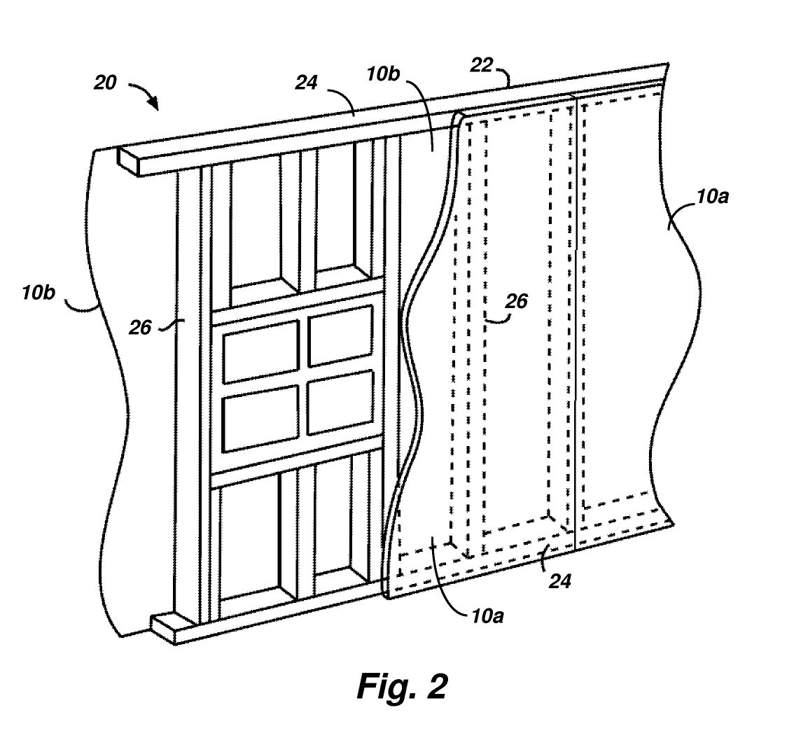

Referring now to FIG. 2, the synthetic building panels 10 advantageously can be used to cover the interior and/or the exterior surfaces formed by traditional framed structures. One example of a traditional framed sidewall 22 is shown in a portion of a building 20. The sidewall 22 is defined by horizontal framing members 24 and vertical framing members 26. Synthetic building panels 10a are configured for application to the internal surfaces of the horizontal framing members 24 and vertical framing members 26. In a similar manner, synthetic building panels 10b are configured for application to the external surfaces of the horizontal framing members 24 and vertical framing members 26 thereby forming an exterior sheathing. The synthetic building panels, 10a and 10b, are advantageously configured for attachment to the horizontal framing members 24 and vertical framing members 26 with conventional fasteners, such as for example nails and screws.

Referring again to FIG. 2, the synthetic building panels 10a can have surface finishes that provide various finishing options, such as the non-limiting examples of smooth surface to provide painting and wall papering options or sanded stucco finishes.

The synthetic building panels 10b can have surface finishes that also provide various finishing options, including the non-limiting options of painting or cladding with various siding materials. In still other embodiments, the synthetic building panels 10b can have an integrated scratch coat finish to facilitate the attachment of masonry products.

While the embodiment of the sidewall 22 shown in FIG. 2 illustrates horizontal framing members 24 and vertical framing members 26 forming a generally open structure having insulation cavities, it should be appreciated that in other embodiments, the synthetic building panels can be also applied to solid walls, that is, wall that do not have a generally open structure, such as for example, walls formed from concrete or masonry materials.

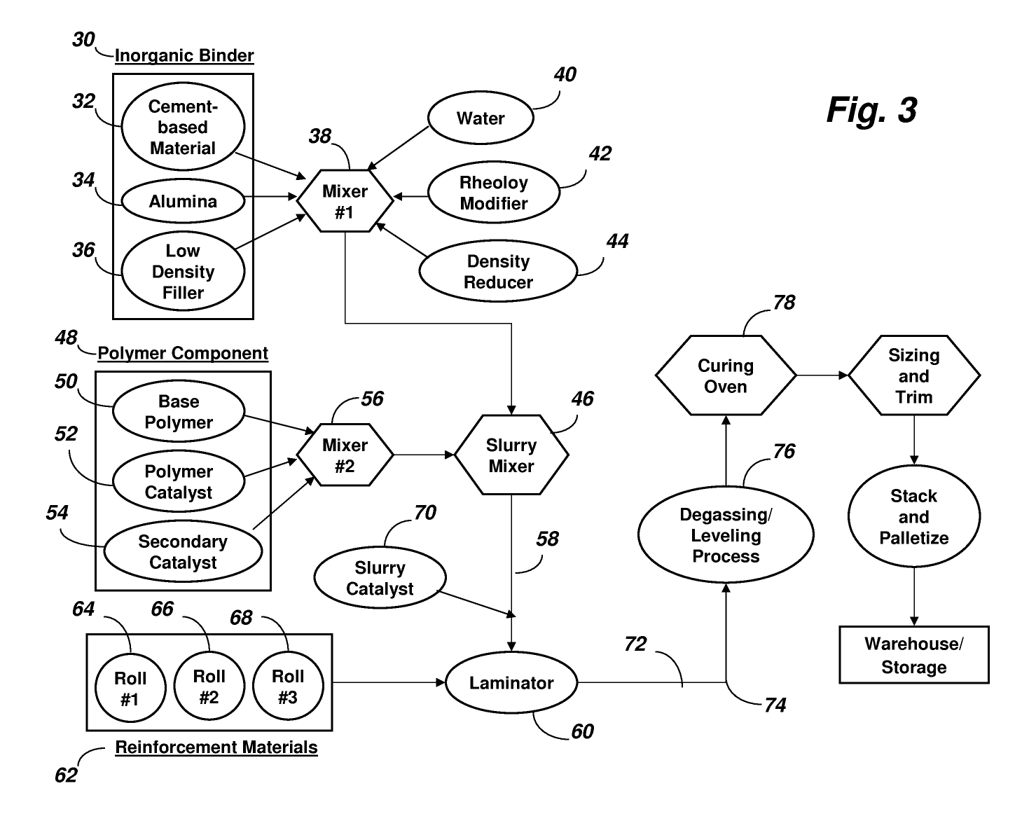

Referring now to FIG. 3, a first embodiment of a manufacturing process for forming the synthetic building panel 10 is illustrated. The dry components forming the inorganic binder 30 are provided. In the illustrated embodiment, the dry components forming the inorganic binder 30 include the cementitious material 32, the alumina 34 and the low density filler 36. As discussed above, the dry components forming the inorganic binder 30 can include other materials.

In the illustrated embodiment, the dry components can be measured by various means, such as for example, a weigh belt (not shown) or a load cell mounted hopper (not shown). In certain embodiments, the dry components forming the inorganic binder 30 are fed into a first mixer 38 by a continuous feed mechanism (not shown). In other embodiments, the dry components forming the inorganic binder 30 can be fed into the first mixer 38 by other mechanisms, such as for example, batch loading mechanisms.

The fluid components forming the inorganic binder 30 are provided. In the illustrated embodiment, the fluid components forming the inorganic binder 30 include the water 40, the rheology modifier 42 and the density reducer 44. As discussed above, the fluid components forming the inorganic binder 30 can include other materials.

In the illustrated embodiment, the fluid components can be measured by various means, such as for example, a flow meter (not shown). In certain embodiments, the fluid components forming the inorganic binder 30 are fed into a first mixer 38 by a continuous feed mechanism (not shown). In other embodiments, the fluid components forming the inorganic binder 30 can be fed into the first mixer 38 by other mechanisms, such as for example, batch loading mechanisms.

The dry components and the fluid components are blended together in the first mixer 38. In a batch-oriented process, the combined dry and fluid components will blend in the first mixer for a desired period of time. In a continuous feed-oriented process, the dry components and the fluid components are introduced, mixed and continuously discharged at a predetermined discharge rate. In either the batch-oriented or a continuous feed-oriented processes, the formed inorganic binder 30 is discharged into a slurry mixer 46.

Concurrent with the formation of the inorganic binder 30, the polymer component 48 is formed. The components forming the polymer component 48 are provided. In the illustrated embodiment, the components forming the polymer component 48 include the base polymer 50, the polymer catalyst 52 and the secondary catalyst 54. As discussed above, the components forming the polymer component 48 can include other materials.

The components forming the polymer component 48 can be measured by various means, such as for example, a flow meter (not shown) and fed into a second mixer 56 by a continuous feed mechanism (not shown) at a predetermined feed rate. The components forming the polymer component 48 are introduced, mixed and continuously discharged from the second mixer 56 into the slurry mixer 46 at a predetermined discharge rate.

The components forming the inorganic binder 30 and the components forming the polymer component 48 are mixed together in the slurry mixer 46. After mixing for a pre-determined time, a polymer modified inorganic binder material 58 is formed. The polymer modified inorganic binder material 58 is discharged from the slurry mixer 46 and conveyed to the laminator 60.

As the polymer modified inorganic binder material 60 is fed into the laminator 60, the reinforcement materials 62 are also provided to the laminator 60. In the illustrated embodiment, the reinforcement materials 62 include a quantity of three layers of synthetic mat or fabric, fed to the laminator 60 from rolls (64, 66 and 68) of various sizes and widths. However, it should be appreciated that more than three layers of reinforcement materials 62 can be provided.

Referring again to FIG. 3, the rate of feed of the reinforcement materials 62 is controlled by a series of rollers (not shown), which are configured to synchronize with the feed rate of the laminator 60. In certain embodiments, the laminator 60 can be operated in a continuous-feed orientation, that is, at a steady and continuous rate. In other embodiments, the laminator 60 can be operated in a batch or panel mode.

In a continuous-feed orientation, the reinforcement materials 62 are impregnated with the polymer modified inorganic binder material 58 by a process that includes passing the individual layers of reinforcement (64, 66 and 66) through a tank (not shown) containing the polymer modified inorganic binder material 58. The dipped layers are then formed into the synthetic panel material by a continuous-feed layering process (not shown). Optionally, a slurry catalyst 70 can be added to the polymer modified inorganic binder material 58 as an intermediate step between the slurry mixer 46 and the laminator 60. While the impregnation of the reinforcement materials 62 has been described as using a dip tank, it should be appreciated that other mechanisms, including a two-sided spray applicator (not shown).

Alternatively, in a batch-feed orientation, the reinforcement materials 62 are impregnated with the polymer modified inorganic binder material 58 by a process that includes passing of individual, discreetly sized panel of reinforcement material (not shown) through a tank (not shown) containing the polymer modified inorganic binder material 58. The discreet panels are then formed into the synthetic panel material having a desired thickness by a layering process that includes sequential passes (not shown) of the dipped panels. In other embodiments, the reinforcement materials 62 can be cut to length at other locations in the forming process.

The laminator 60 forms a slurry-coated reinforcement material 72. The slurry coated reinforcement material 72 is conveyed to downstream operations by a conveyor 74. In the illustrated embodiment, the conveyor 74 is a moving belt. Alternatively, the conveyor 74 can be other mechanisms or combinations of mechanisms.

The conveyor 74 passes the slurry-coated reinforcement material 72 through a series of leveling and degassing processes 76. These process are configured to produce the desired panel thickness while insuring contact between the discreet reinforcement layers. At this point, the slurry-coated reinforcement material 72 will have a smooth surface. If desired, a texture may be applied to the slurry-coated reinforcement material 72 prior to entering the curing oven 78.

The curing oven 78 can take various forms and operate with various methods. In certain embodiments, the curing oven 78 can be of a linear design wherein the slurry-coated reinforcement material 72 is gradually brought up to a temperature of about 150° F., held at that temperature for a time and lowered back to ambient to ambient plus 40° F. In other embodiments, the curing oven 78 can be of other designs, including a discontinuous design configured to receive individual panel molds, conveying the individual panels molds vertically in an upward direction (increasing temperature), then horizontally (150° F. hold), then vertically in a downward direction (decreasing temperature.

Referring again to FIG. 3, the amount of time required to provide initial cure may be as short as 1 minute or as long as 1 hour, depending upon the slurry catalyst 70 provided. The curing oven 78 forms cured slurry-coated reinforcement material 80.

Upon exiting the curing oven 78, the cured slurry-coated reinforcement material 80 is edge trimmed and then cut to the desired panel length. Any desire trimming and cutting mechanisms can be used.

The synthetic building panels 10 can be stacked. In certain embodiments, the synthetic building panels 10 are rigidly supported at both the top and bottom of the stacked panels. The stacks may then be banded and removed to a storage facility for an additional seven days of curing.

While the manufacturing process described above can be used to manufacture the synthetic building panels 10, it should be appreciated that other manufacturing processes can be used.

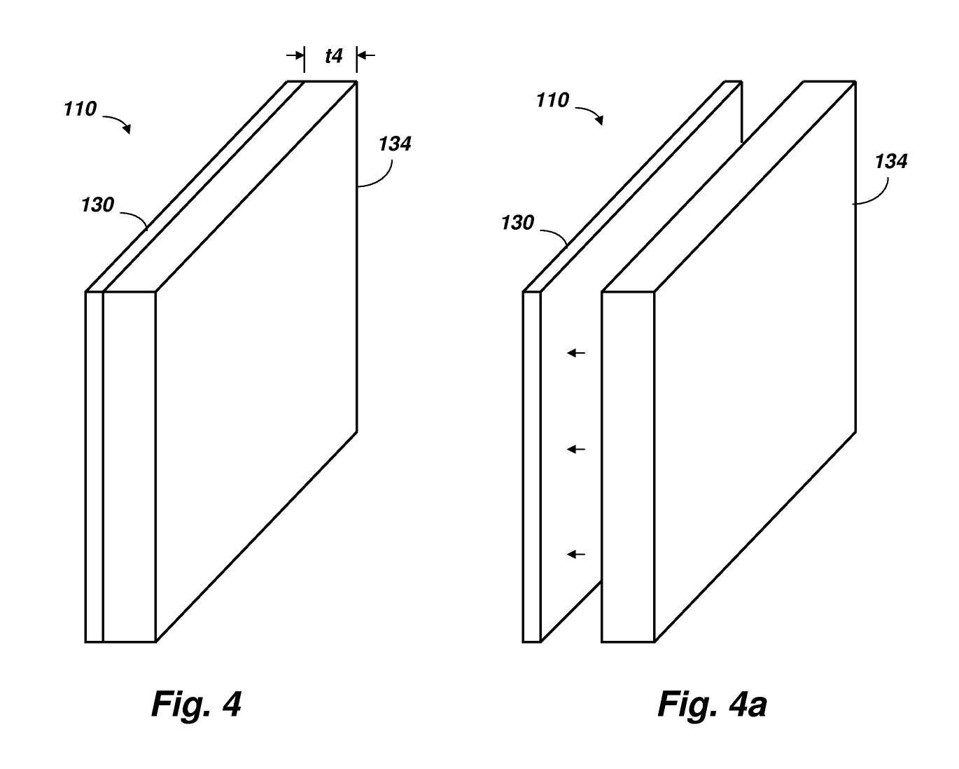

In another embodiment illustrated in FIGS. 4 and 4a, an insulated synthetic building panel 110 is shown. The insulated synthetic building panel 110 includes a reinforced layer 130 and an insulation layer 134. Generally, the insulated synthetic building panel 110 provides improved insulative values (R) over the synthetic building panel 10 as shown in FIG. 1 and discussed above. In the illustrated embodiment, the reinforced layer 130 is the same as, or similar to the synthetic building panel 10 illustrated in FIG. 1 and discussed above. However, it should be appreciated that in other embodiments the reinforced layer 130 can be different than the synthetic building panel 10.

Referring again to FIG. 4, the insulation layer 134 is formed from a rigid foam insulation material. One example of a rigid foam insulation material is Foamular® rigid foam insulation marketed by Owens Corning Corporation, headquartered in Toledo, Ohio.

Referring again to FIG. 4, the insulation layer 134 has a thickness t4. In the illustrated embodiment, the thickness t4 is in a range of from about 0.50 inches (12.7 mm) to about 8.00 inches (203.2 mm). In other embodiments, the thickness t4 can be less than about 0.50 inches (12.7 mm) or more than about 8.00 inches (203.2 mm).

In the embodiment illustrated in FIG. 4, the insulation layer 134 has a thermal resistance (R) in a range of from about 1 to about 6 per 0.75 inches of insulation layer thickness. In other embodiments, the thermal resistance (R) can be less than about 1 or more than about 6 per 0.75 inches of insulation layer thickness. As will be explained in more detail below, the synthetic building panel 110 can be installed in a building in various manners.

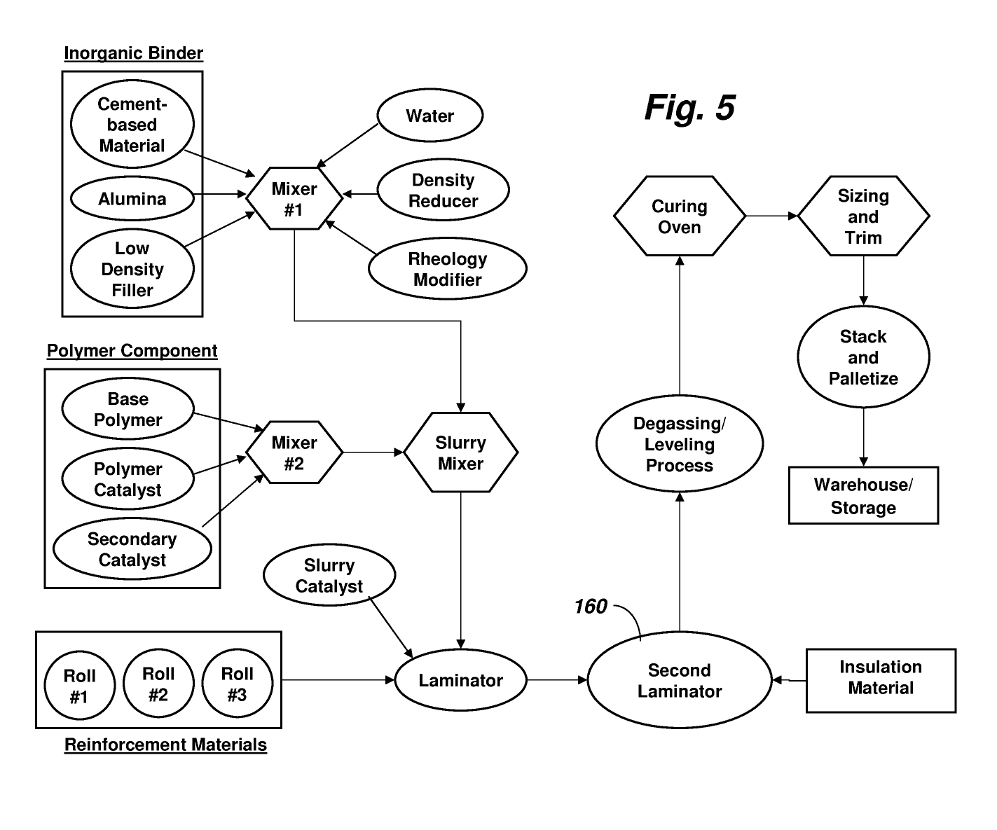

Referring now to FIG. 4a, the reinforced layer 130 and the insulation layer 134 are joined together to form the insulated synthetic building panel 110. In the illustrated embodiment, the reinforced layer 130 and the insulation layer 134 are joined together by an adhesive process, as shown in FIG. 5 and described below. In other embodiments, the reinforced layer 130 and the insulation layer 134 can be joined together by other manufacturing processes, including the non-limiting examples of ultra-sonic welding and thermal bonding.

Referring now to FIG. 5, a first embodiment of a manufacturing process for forming the insulated synthetic building panel 110 is illustrated. Generally, the manufacturing process illustrated in FIG. 5 is the same as the manufacturing process illustrated in FIG. 3 with a few key exceptions.

First, a second laminator 160 is provided. The second laminator 160 is configured to join the reinforced layer 130 to the insulation layer 134. The joining of the reinforced layer 130 to the insulation layer 134 can be accomplished using various production techniques, including the non-limiting examples of in-line or off-line processes.

In the case of an “in-line” process, the steps shown in FIG. 3 for forming the synthetic building panel 10 are joined with a production line for extruded polystyrene foam after the polystyrene foam has received surface profiling and prior to the normal cut to size steps. Alternately, an off-line process may be used. In this case, the expanded or extruded polystyrene boards are prepared to size and inserted into forms. These forms serve to position the insulating foam board as well as providing edge containment for the applied slurry and reinforcement material.

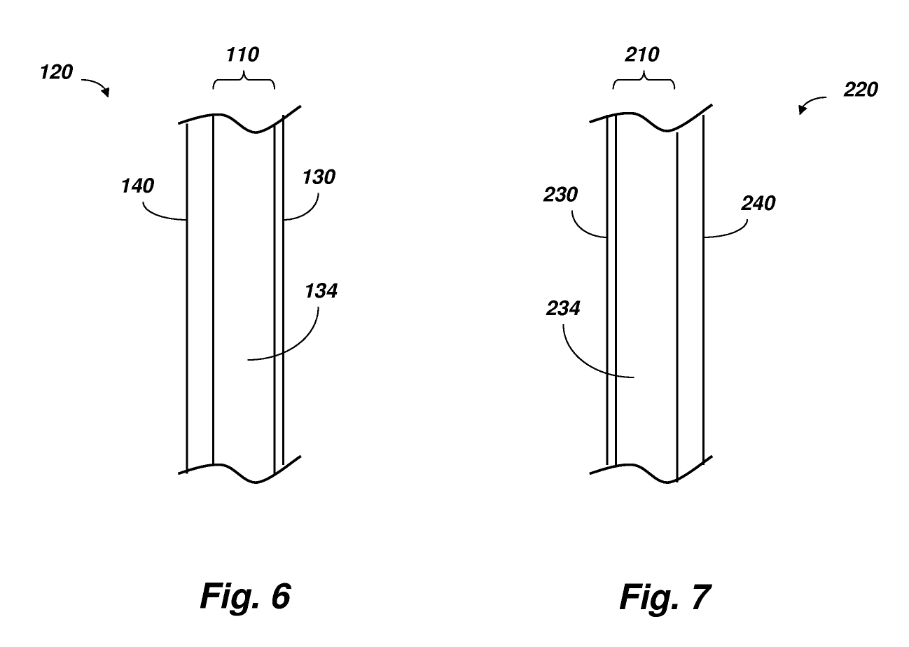

Referring now to FIGS. 6 and 7, the insulated synthetic building panel 110 can be incorporated into a building wall. Referring first to FIG. 6, a portion of a first embodiment of a building wall 120 is illustrated. The building wall 120 has a concrete layer 140 in contact with the insulated synthetic building panel 110. The insulated synthetic building panel 110 includes the reinforced layer 130 and the insulation layer 134. The concrete layer 140 is positioned to be on the exterior side of the building wall 120 and the reinforced layer 130 is positioned to be on the interior side of the building wall 120. Accordingly, the insulation layer 134 is positioned to be between the concrete layer 140 and the reinforced layer 130.

In operation, the building wall 120 is formed by first positioning the insulated synthetic building panel 110 in a generally vertical orientation in concrete forms (not shown) such that the reinforced layer 130 is positioned to be on the interior side of the building wall 120. Next, the concrete layer 140 is formed by introducing concrete into the concrete forms such that the concrete is in contact with the insulation layer 134. The concrete forming the concrete layer 140 is allowed to cure and the concrete forms are removed. The formed building wall 120 advantageously provides an inexpensive, quickly formed building wall 120 having a desired thermal resistance (R) rating.

Referring now to FIG. 7, a second embodiment of a building wall 220 is illustrated. The building wall 220 has a concrete layer 240 in contact with an insulated synthetic building panel 210. In the illustrated embodiment, the concrete layer 240 and the insulated synthetic building panel 210 are the same as, or similar to, the concrete layer 140 and the insulated synthetic building panel 110 illustrated in FIG. 6 and discussed above. However, it should be appreciated that in other embodiments, the concrete layer 240 and the insulated synthetic building panel 210 can be different than the concrete layer 140 and the insulated synthetic building panel 110. The insulated synthetic building panel 210 includes the reinforced layer 230 and the insulation layer 234.

In the embodiment illustrated in FIG. 7, the concrete layer 240 is positioned to be on the interior side of the building wall 220 and the reinforced layer 230 is positioned to be on the exterior side of the building wall 220. Accordingly, the insulation layer 234 is positioned to be between the concrete layer 240 and the reinforced layer 230. The building wall 220 is formed in a similar manner as discussed above for building wall 120.

While the embodiments illustrated in FIGS. 6 and 7 shown the synthetic building panel (110, 210) incorporated into a concrete wall (120, 220), it should be appreciated that in other embodiments, the synthetic building panel (110, 210) can be applied to traditional framed structures, such as for example, the sidewall 22 as shown in FIG. 2. The synthetic building panel (110, 210) can be applied as described above.

The principle and mode of installation of the synthetic building panel have been described in certain embodiments. However, it should be noted that the synthetic building panel may be practiced otherwise than as specifically illustrated and described without departing from its scope.

What is claimed is:

1. A synthetic building panel configured to cover a wall surface, the synthetic building panel comprising:
a plurality of slurry-based layers; and
a plurality of reinforcement layers interspersed between and in contact with the plurality of slurry-based layers;
wherein the material forming the slurry-based layers is a polymer modified inorganic binder material.

2. The synthetic building panel of claim 1, wherein the panel has a density in a range of from about 30.0 lb/ft³ (0.48 g/cc) to about 180.0 lb/ft³ (2.88 g/cc).

3. The synthetic building panel of claim 1, wherein the panel has a thickness of 3.0 mm and a weight in a range of from about 0.10 lb/ft² (0.49 kg/m²) to about 0.80 lb/ft² (3.90 kg/m²).

4. The synthetic building panel of claim 1, wherein the panel has a moisture transmission rating in a range of from about 80 coulombs to about 250 coulombs.

5. The synthetic building panel of claim 1, wherein the panel has a thickness in a range of from about 0.125 inches (3.175 mm) to about 1.0 inches (25.4 mm).

6. The synthetic building panel of claim 1, wherein the slurry-based layers are formed from a combination of polymer base components, polymer catalysts, cementitious material, alumina, low density fillers and water.

7. The synthetic building panel of claim 1, wherein each of the slurry-based layers has a thickness in a range of from about 0.02 inches (0.40 mm) to about 0.04 inches (0.80 mm).

8. The synthetic building panel of claim 1, wherein the reinforcement layers are mats formed from fibrous materials.

9. The synthetic building panel of claim 8, wherein the mats are woven.

10. The synthetic building panel of claim 1, wherein the mats have a thickness in a range of from about 0.0019 inches (0.05 mm) to about 0.011 inches (0.3 mm).

11. The synthetic building panel of claim 1, wherein the quantity of reinforcement layers is in a range of from about 1 to about 20.

12. The synthetic building panel of claim 1, wherein an insulation layer is attached to the panel.

13. The synthetic building panel of claim 12, wherein the insulation layer has a thickness in a range of from about 0.50 inches (12.7 mm) to about 8.0 inches (203.2 mm).

14. A synthetic building panel configured to cover a wall surface, the synthetic building panel comprising:
a slurry-based layer formed from a polymer modified inorganic binder material mixed with discrete loose fibers;
wherein the discrete loose fibers are configured as a reinforcement material.

15. The synthetic building panel of claim 14, wherein the panel has a density in a range of from about 30.0 lb/ft³ (0.48 g/cc) to about 180.0 lb/ft³ (2.88 g/cc).

16. The synthetic building panel of claim 14, wherein the panel has a thickness of 3.0 mm and a weight in a range of from about 0.10 lb/ft² (0.49 kg/m²) to about 0.80 lb/ft² (3.90 kg/m²).

17. The synthetic building panel of claim 14, wherein the panel has a moisture transmission rating in a range of from about 80 coulombs to about 250 coulombs.

18. The synthetic building panel of claim 14, wherein the slurry-based layers are formed from a combination of polymer base components, polymer catalysts, cementitious material, alumina, low density fillers and water.

19. The synthetic building panel of claim 14, wherein an insulation layer is attached to the panel.

20. A building wall comprising;
a plurality of synthetic building panels configured to cover a wall surface, each of the synthetic building panels having a plurality of slurry-based layers and a plurality of reinforcement layers interspersed between and in contact with the plurality of slurry-based layers, wherein the material forming the slurry-based layers is a polymer modified inorganic binder material;
an insulation layer attached to each of the synthetic building panels; and
a layer of concrete in contact with each of the insulation layers.
